(19) United States
(12) Patent Application Publication
(10) Pub. No.: US 2023/0418650 A1
(43) Pub. Date: Dec. 28, 2023

(54) SYSTEM AND METHOD FOR SHARING SECRET WITH AN AGENT RUNNING IN A VIRTUAL COMPUTING INSTANCE

(71) Applicant: VMWARE, INC., Palo Alto, CA (US)

(72) Inventors: ANKUR GUPTA, Pune (IN); Rushit DESAI, Pune (IN); Anant BOBDE, Pune (IN); Ashwini PARANJPE, Pune (IN)

(21) Appl. No.: 17/895,120

(22) Filed: Aug. 25, 2022

(30) Foreign Application Priority Data
Jun. 28, 2022 (IN) 202241037000

(51) Int. Cl. G06F 9/455; G06F 9/50; G06F 9/54

(52) U.S. Cl. CPC G06F 9/45558; G06F 2009/45595; G06F 9/541; G06F 9/5072

(57) ABSTRACT

A system and method for sharing secrets with virtual computing instances in a distributed system uses a time-to-live (TTL) address written in a virtual computing instance using a cluster management center that manages the virtual computing instance as part of a logical cluster of virtual computing instances. The secret information is retrieved when the TLL address is invoked. The secret information is used to execute an operation that requires the secret information.

### RELATED APPLICATIONS

Benefit is claimed under 35 U.S.C. 119(a)-(d) to Foreign Application Serial No. 202241037000 filed in India entitled “SYSTEM AND METHOD FOR SHARING SECRET WITH AN AGENT RUNNING IN A VIRTUAL COMPUTING INSTANCE”, on Jun. 28, 2022, by VMware, Inc., which is herein incorporated in its entirety by reference for all purposes.

### BACKGROUND

In a managed data center, enterprise applications, databases and/or workloads often need to access trusted resources. As an example, an agent running inside a virtual machine needs to communicate with a Carbon Black Cloud (CBC). In order to execute this communication with the CBC in a secure manner, the agent needs a secret, e.g., an application programming interface (API) token, to establish trust with REST endpoint exposed by the Carbon Black Cloud.

There are conventional approaches to share the secret with an agent running in a virtual machine so that the agent can securely communicate with the CBC. However, these conventional approaches do not have sufficient safeguards and may expose the secret to unauthorized entities.

### SUMMARY

A system and method for sharing secrets with virtual computing instances in a distributed system uses a time-to-live (TTL) address written in a virtual computing instance using a cluster management center that manages the virtual computing instance as part of a logical cluster of virtual computing instances. The secret information is retrieved when the TLL address is invoked. The secret information is used to execute an operation that requires the secret information.

A computer-implemented method for sharing secrets with virtual computing instances in a distributed system in accordance with an embodiment of the invention comprises writing a time-to-live (TTL) address in a virtual computing instance to access secret information using a cluster management center that manages the virtual computing instance as part of a logical cluster of virtual computing instances, wherein the TTL address is valid during a specified time, invoking the TTL address written in the virtual computing instance to retrieve the secret information, and using the secret information to execute an operation that requires the secret information. In some embodiments, the steps of this method are performed when program instructions contained in a non-transitory computer-readable storage medium are executed by one or more processors.

A system in accordance with an embodiment of the invention comprises memory and at least one processor configured to write a time-to-live (TTL) address in a virtual computing instance to access secret information using a cluster management center that manages the virtual computing instance as part of a logical cluster of virtual computing instances, wherein the TTL address is valid during a specified time, invoke the TTL address written in the virtual computing instance to retrieve the secret information, and use the secret information to execute an operation that requires the secret information.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a distributed computer system in accordance with an embodiment of the invention.

FIG. 2 illustrates how credentials for a forward proxy server can be shared with a service agent using the guest info variables in a designated VM in the distributed computer system in accordance with prior art.

FIG. 3 illustrates how the credentials for the forward proxy server can be shared using the data set of a designated VM in the distributed computer system in accordance with prior art.

FIG. 4 illustrates how the credentials for the forward proxy server can be shared using a secure secret sharing approach in accordance with an embodiment of the invention.

FIG. 5 is a process flow diagram of a process of sharing proxy server details and credentials for the forward proxy server with a service agent running in a designated VM in the distributed computing system in accordance with an embodiment of the invention.

FIG. 6 is a process flow diagram of a process of sharing proxy server details and credentials for the forward proxy server with a designated VM in the distributed computing system to download a service agent from a cloud-based service in accordance with an embodiment of the invention.

FIG. 7 is a flow diagram of a computer-implemented method for sharing secrets with virtual computing instances in a distributed system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

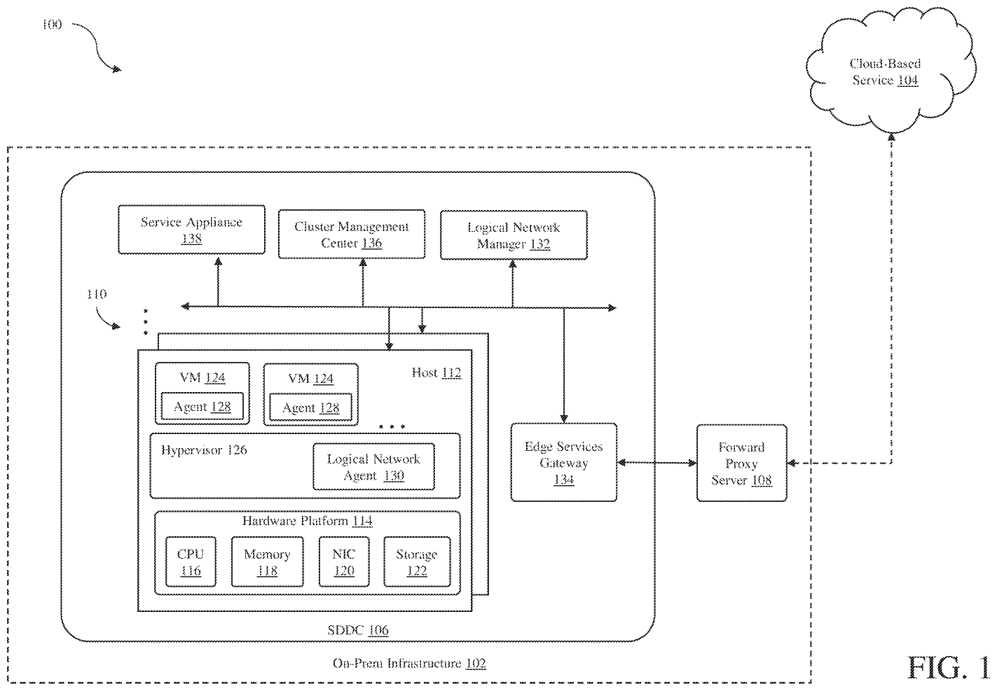

Turning now to FIG. 1, a distributed computing system 100 in accordance with an embodiment of the invention is illustrated. The distributed computing system 100 includes an on-premises (on-prem) infrastructure 102 and a cloud-based service 104 running in a public cloud. The on-prem infrastructure 102 includes a software-defined data center (SDDC) 106 and a forward proxy server 108, which provides connection to the cloud-based service 104. In an embodiment, the forward proxy server 108 requires authentication to be connected to the cloud-based service 104 from the SDDC 106. The authentication may be provided by credentials (e.g., username and password), application programming interface (API) token or other authentication data.

The cloud-based service 104 is a system in the public cloud that can provide any service to entities running in the on-prem infrastructure 102. In an embodiment, the cloud-based service is a software-as-a-service (SaaS) security solution that provides endpoint detection and response (EDR), advanced threat hunting and vulnerability management using sensor agents at endpoints, which are typically end-user devices, such as virtual and physical computers, tablets or smartphones. Thus, the cloud-based service may need to communicate with the sensor agents or the computing devices on which the sensor agents are running. As an example, the cloud-based service 104 may be the VMware Black Carbon Cloud™.

As shown in FIG. 1, the SDDC 106 includes a cluster 110 of host computers (“hosts”) 112, which is a logical grouping of hosts. The hosts 112 may be constructed on a server grade hardware platform 114, such as an x86 architecture platform. As shown, the hardware platform 114 of each host 112 may include conventional components of a computer, such as one or more processors (e.g., CPUs) 116, system memory 118, a network interface 120, and storage 122. The processor 116 can be any type of a processor commonly used in servers. The memory 118 is volatile memory used for retrieving programs and processing data. The memory 118 may include, for example, one or more random access memory (RAM) modules. The network interface 120 enables the host 112 to communicate with other devices that are inside or outside of the SDDC 106 via a communication network. The network interface 120 may be one or more network adapters, also referred to as network interface cards (NICs). The storage 122 represents one or more local storage devices (e.g., one or more hard disks, flash memory modules, solid state disks and/or optical disks), which may be part of a virtual storage (e.g., virtual storage area network (SAN)).

Each host 112 may be configured to provide a virtualization layer that abstracts processor, memory, storage and networking resources of the hardware platform 114 into virtual computing instances (VCIs) 124 that run concurrently on the same host. As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the invention described herein are not limited to virtual machines (VMs).

In the illustrated embodiment, the VCIs in the form of VMs 124 are provided by host virtualization software 126, which is referred to herein as a hypervisor, that enables sharing of the hardware resources of the host by the VMs. One example of the hypervisor 126 that may be used in an embodiment described herein is a VMware ESXi™ hypervisor provided as part of the VMware vSphere® solution made commercially available from VMware, Inc. The hypervisor 126 may run on top of the operating system of the host or directly on hardware components of the host. For other types of VCIs, the host may include other virtualization software platforms to support those VCIs, such as Docker virtualization platform to support “containers”. Although embodiments of the inventions may involve other types of VCIs, various embodiments of the invention are described herein as involving VMs.

Each VM 124 may also include a service agent 128, which operates with the cloud-based service 104 through the forward proxy server 108. In an embodiment, each service agent may be an endpoint sensor that communicates with the cloud-based service 104 through the forward proxy server 108 to facilitate the SaaS security solution. Thus, each service agent 128 may need to be trusted by the forward proxy server 108 by providing the necessary authentication data, e.g., proper credentials. This information needs to be kept safe so that unauthorized access to the forward proxy server 108 is prevented. However, this information must also be shared with the service agent 128 so that the service agent can use the information for authentication to access the forward proxy server 108. As described in detail below, a secret sharing approach in accordance with an embodiment is used to provide secret information, e.g., authentication data, to one or more service agents 128 so that the service agents can communicate with the cloud-based service 104 via the forward proxy server 108.

In the illustrated embodiment, the hypervisor 126 includes a logical network (LN) agent 130, which operates to provide logical networking capabilities, also referred to as “software-defined networking”. Each logical network may include software managed and implemented network services, such as bridging, L3 routing, L2 switching, network address translation (NAT), and firewall capabilities, to support one or more logical overlay networks in the SDDC 106. The logical network agent 130 may receive configuration information from a logical network manager 132 (which may include a control plane cluster) and, based on this information, populates forwarding, firewall and/or other action tables for dropping or directing packets between the VMs 124 in the host 112, other VMs on other hosts, and/or other devices outside of the SDDC 106. Collectively, the logical network agent 130, together with other logical network agents on other hosts, according to their forwarding/routing tables, implement isolated overlay networks that can connect arbitrarily selected VMs with each other. Each VM may be arbitrarily assigned a particular logical network in a manner that decouples the overlay network topology from the underlying physical network. Generally, this is achieved by encapsulating packets at a source host and decapsulating packets at a destination host so that VMs on the source and destination can communicate without regard to the underlying physical network topology. In a particular implementation, the logical network agent 130 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols, such as stateless transport tunneling (STT), Network Virtualization using Generic Routing Encapsulation (NVGRE), or Geneve, instead of, or in addition to, VXLAN.

The hypervisor 126 may also include a local scheduler and a high availability (HA) agent, which are not illustrated. The local scheduler operates as a part of a resource scheduling system that provides load balancing among enabled hosts 112 in the cluster 110. The HA agent operates as a part of a high availability system that provides high availability of select VMs running on the hosts 112 in the cluster 110 by monitoring the hosts, and in the event of a host failure, the VMs on the failed host are restarted on alternate hosts in the cluster.

As noted above, the SDDC 106 also includes the logical network manager 132 (which may include a control plane cluster), which operates with the logical network agents 130 in the hosts 112 to manage and control logical overlay networks in the SDDC. In some embodiments, the SDDC 106 may include multiple logical network managers that provide the logical overlay networks of the SDDC. Logical overlay networks comprise logical network devices and connections that are mapped to physical networking resources, e.g., switches and routers, in a manner analogous to the manner in which other physical resources as compute and storage are virtualized. In an embodiment, the logical network manager 132 has access to information regarding physical components and logical overlay network components in the SDDC 106. With the physical and logical overlay network information, the logical network manager 132 is able to map logical network configurations to the physical network components that convey, route, and filter physical traffic in the SDDC 106. In a particular implementation, the logical network manager 132 is a VMware NSX® Manager™ product running on any computer, such as one of the hosts 112 or VMs 124 in the SDDC 106.

The SDDC 106 also includes one or more edge services gateway 134 to control network traffic into and out of the SDDC. In a particular implementation, the edge services gateway 134 is VMware NSX® Edge™ product made available from VMware, Inc. running on any computer, such as one of the hosts 112 or VMs 124 in the SDDC 106. The logical network manager(s) 132 and the edge services gateway(s) 134 are part of a logical network platform, which supports the software-defined networking in the SDDC 106.

The SDDC 106 further includes a cluster management center 136, which operates to manage and monitor the cluster 110 of hosts 112. The cluster management center 136 may be configured to allow an administrator to create a cluster of hosts, add hosts to the cluster, delete hosts from the cluster and delete the cluster. The cluster management center 136 may further be configured to monitor the current configurations of the hosts 112 in the cluster 110 and the VMs running on the hosts. The monitored configurations may include hardware and/or software configurations of each of the hosts 112. The monitored configurations may also include VM hosting information, i.e., which VMs are hosted or running on which hosts. In order to manage the hosts 112 and the VMs 124 in the cluster 110, the cluster management center 136 support or execute various operations. As an example, the cluster management center 136 may be configured to perform resource management operations for the cluster 110, including VM placement operations for initial placement of VMs and load balancing.

In an embodiment, the cluster management center 136 provides an application programming interfaces (APIs) to write to and read from data sets of the VMs 124 running in the hosts 112. The data set of a VM is secured data stored in storage, e.g., a datastore, associated with the VM that can only be written to or read from with certain access privileges, such as administrator or root. The cluster management center 136 also has access privileges for the data sets of VMs. Thus, the data sets of VMs can also be accessed by software entities using the data set APIs of the cluster management center 136.

In an embodiment, the cluster management center 136 is a computer program that resides and executes in a computer system, such as one of the hosts 112, or in one of the VMs 124 running on the hosts 112. One example of the cluster management center 136 is the VMware vCenter Server® product made available from VMware, Inc.

In the illustrated embodiment, the SDDC 106 includes a service appliance 138, which allows administrators to control various aspects of the services provided by the cloud-based service 104. As described in more detail below, the service appliance 138 has the capabilities of creating REST endpoints to provide trusted resources. As an example, the service appliance 138 may be a Carbon Black Cloud Workload Protection (CWP) appliance.

In an embodiment, at least some of the components of the SDDC 106, such as the logical network manager 132, the edge services gateway 134, the cluster management center 136 and/or the service appliance 138, may be implemented in one or more virtual computing instance, e.g., VMs 124, running in the SDDC. In some embodiments, there may be multiple instances of the logical network manager 132 and the edge services gateway 134 and the cluster management center 136 that are deployed in the SDDC 106.

As described above, secret information, e.g., authentication data, may need to be shared with the service agents 128 running on the VMs 124 in the SDDC 106. The secret information may be held in the service appliance 138. Thus, there is a need for a data sharing approach to securely share secret information in the cloud-based service with the service agents running on the VMs in the SDDC.

One possible approach to share the secret information with the service agents 128 running on the VMs 124 in the SDDC 106 is to use guest info variables offered by the cluster management center. Guest info variables are provided by the cluster management center 136 in its own space, which can be accessed by designated VMs 124.

Thus, these guest info variables, which are exposed by the cluster management center 136, can be used as a mechanism to share data between the cluster management center and one or more VMs 124 managed by the cluster management center as part of the cluster 110 of hosts 112. The cluster management center 136 may be configured to expose a set of APIs to manage the guest info variables. Using these APIs, one can write secret information, e.g., credentials for the forward proxy server 108, in the guest info variables that can be read by a designated VM 124 to communicate with the cloud-based service 104 through the forward proxy server 108.

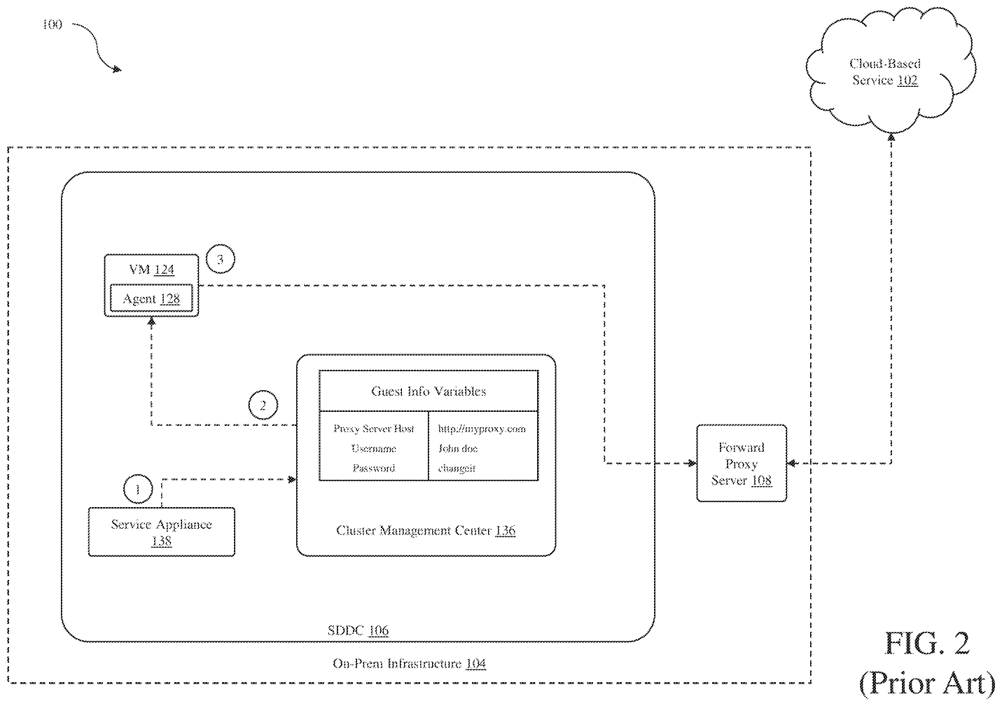

FIG. 2 illustrates how the credentials, e.g., username and password, for the forward proxy server 108 can be shared with a service agent 128 using the guest info variables in a designated VM 124 in accordance with prior art. In FIG. 2, only the service appliance 138, the cluster management center 136 and the designated VM 124 of the SDDC 106 are shown. At step 1, details of the forward proxy server 108 (hereinafter “forward proxy details”) and credentials for the forward proxy server 108 are written or populated in the guest info variables stored in the cluster management center 136 by the service appliance 138 using an appropriate API of the cluster management center 136. The proxy server details may include the address, e.g., the Uniform Resource Locator (URL) of the forward proxy server. The credentials for the forward proxy server 108 may include username and password, or other authenticating data. Next, at step 2, the forward proxy details and the credentials are then pulled or read by the service agent 128 running in the VM 124 to establish a trust with the forward proxy server 108. Next, at step 3, after establishing trust with the forward proxy server 108 using the credentials, the service agent 128 is able to communicate with the cloud-based service 102 through the forward proxy server 108.

A shortcoming with this approach is that the guest info variables, which include the secret information, are available in world readable form on the cluster management server space. Hence, the guest info variables are readily available for unintended or unauthorized use. For example, a cyber attacker can steal and leverage this sensitive information for unauthorized activities, which poses security threats.

Another possible approach to provide secret to a designated virtual machine 124, and ultimately to the service agent 128 running in the virtual machine, is to use data set API, which is a different way of writing, reading and storing data on workload VM space that may be offered by the cluster management center 136. The data set API provides a set of REST interfaces to read and write secret information, e.g., credentials for the forward proxy server, directly on the designated VM 124. The secret information can then be read by the service agent 128 running on the VM 124 to communicate with the cloud-based service 104 through the forward proxy server 108.

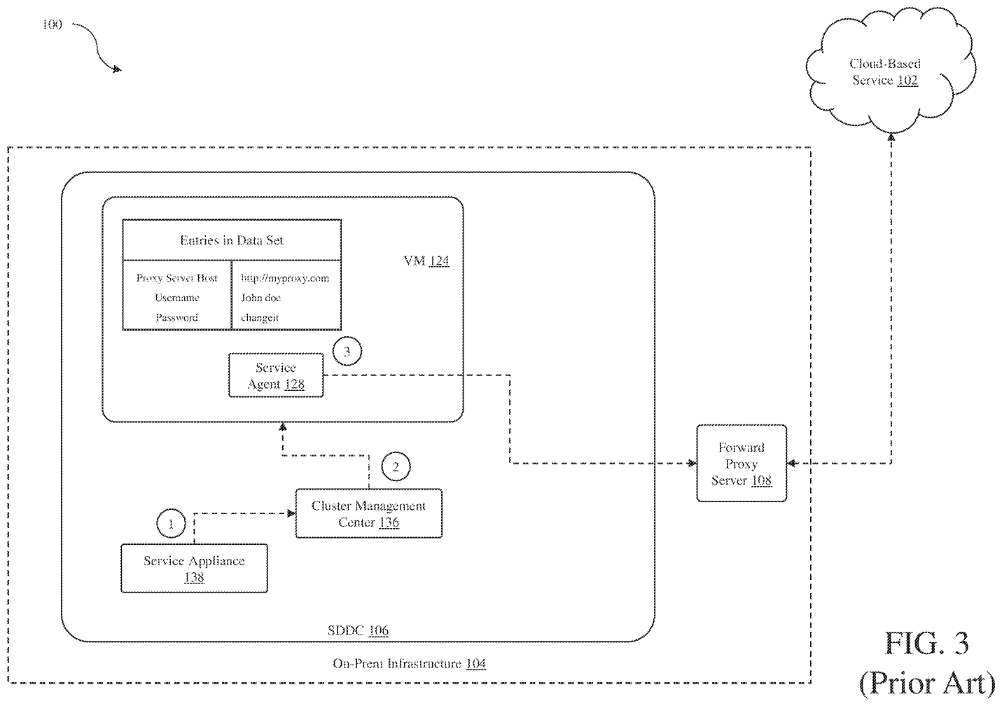

FIG. 3 illustrates how the credentials, e.g., username and password, for the forward proxy server 108 can be shared using the data set of a designated VM 124 in accordance with prior art. Similar to FIG. 2, in FIG. 3, only the service appliance 138, the cluster management center 132 and the designated VM 124 of the SDDC 106 are shown. At step 1, the data set API on the cluster management center 132 is invoked by the service appliance 138. Next, at step 2, the forward proxy details and the credentials for the forward proxy server 108 are written in the data set of the VM 124 by the cluster management center 136. Next, at step 3, the forward proxy details and the credentials are read by the service agent 128 running on the VM 124 and used to establish trust with the forward proxy server 108 and to communicate with the cloud-based service 102 through the forward proxy server 108.

A shortcoming with this second approach is that all the data stored in the data set of the VM 124 is accessible by an administrator or root user of that VM. If one or more snapshots of the VM are taken and distributed to other users, then the secret information in the data set may be accessed by these unintended users.

In accordance with embodiments of the invention, the distributed computing system 100 uses a secure secret sharing approach based on the data set APIs that overcomes the shortcomings of the two secret sharing approaches described above. In this secure secret sharing approach, rather than writing the secret information directly in the workload VM space, a Time-to-Live (TLL) REST endpoint, which is exposed by another entity, such as the service appliance 138, is written. A TLL REST endpoint is a REST endpoint that has a lifespan of a specified time or duration. Thus, the REST endpoint will only be valid during the specified duration or TTL duration. After the predefined duration of time, the REST endpoint will no longer be valid, i.e., the REST endpoint cannot be accessed.

In an embodiment, this TTL REST endpoint is a single-use URL, which provides the secret information, e.g., credentials for the forward proxy server, in response to an invocation by a requesting entity, e.g., a service agent 128 of a designated VM 124. Thus, the single-use URL can be invoked by the service agent 128 to get credentials, such as username and password, for the forward proxy server. After obtaining the credentials, a trust can be established with the forward proxy server 108 by the service agent 128 using the credentials to connect with the cloud-based service 102 through the forward proxy server 108. Once the single-use URL has been accessed, the single-use URL cannot be used again by the service agent 128 or any other entity to retrieve the username and password. In addition, if the single-use URL is not invoked within the TTL duration, then the single-use URL will automatically be invalidated. Thus, the single-use URL can be viewed as a single-use TTL REST endpoint URL that is valid only when invoked for the first time during the TTL duration.

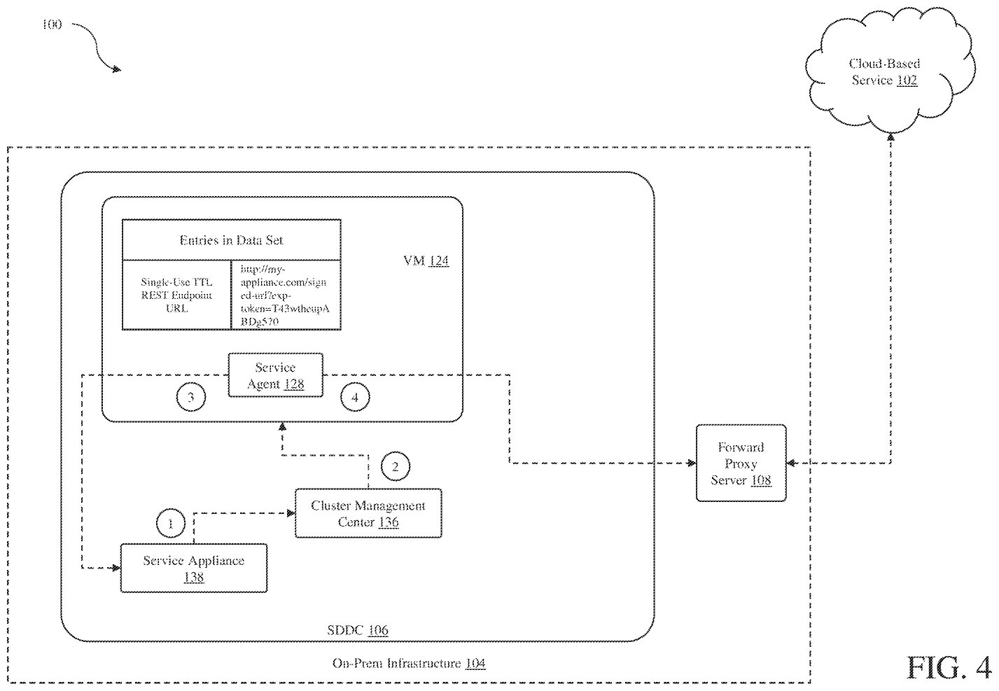

FIG. 4 illustrates how the credentials, e.g., username and password, for the forward proxy server 108 can be shared using the secure secret sharing approach in accordance with an embodiment of the invention. Similar to FIGS. 2 and 3, in FIG. 4, only the service appliance 138, the cluster management center 132 and a designated VM 124 of the SDDC 106 are shown. At step 1, the data set API on the cluster management center 136 is invoked by the service appliance 138 to write a single-use TTL REST endpoint URL, which when invoked will provide the forward proxy details and the credentials for the forward proxy server 108. Next, at step 2, the single-use TTL REST endpoint URL is written in the data set of the VM 124 by the cluster management center 136. Next, at step 3, the forward proxy details and the credentials for the forward proxy server 108 are retrieved from the service appliance 138 by the service agent 128 running on the VM 124 using the single-use TTL REST endpoint URL. Next, at step 4, the retrieved proxy server details and credentials are read by the service agent 128 running on the VM 124 and used to establish trust with the forward proxy server 108 to communicate with the cloud-based service 102 through the forward proxy server 108.

After the single-use TTL REST endpoint URL is invoked for the first time, the single-use TTL REST endpoint URL is invalidated by the service appliance 138 so that the forward proxy details and the credentials for the forward proxy server 108 are not provided when the single-use TTL REST endpoint URL is invoked again. Furthermore, if the single-use TTL REST endpoint URL has not been invoked and the TTL duration of the single-use TTL REST endpoint URL has lapsed, the single-use TTL REST endpoint URL is similarly invalidated by the service appliance 138 so that the forward proxy details and the credentials for the forward proxy server 108 are not provided when the single-use TTL REST endpoint URL is invoked.

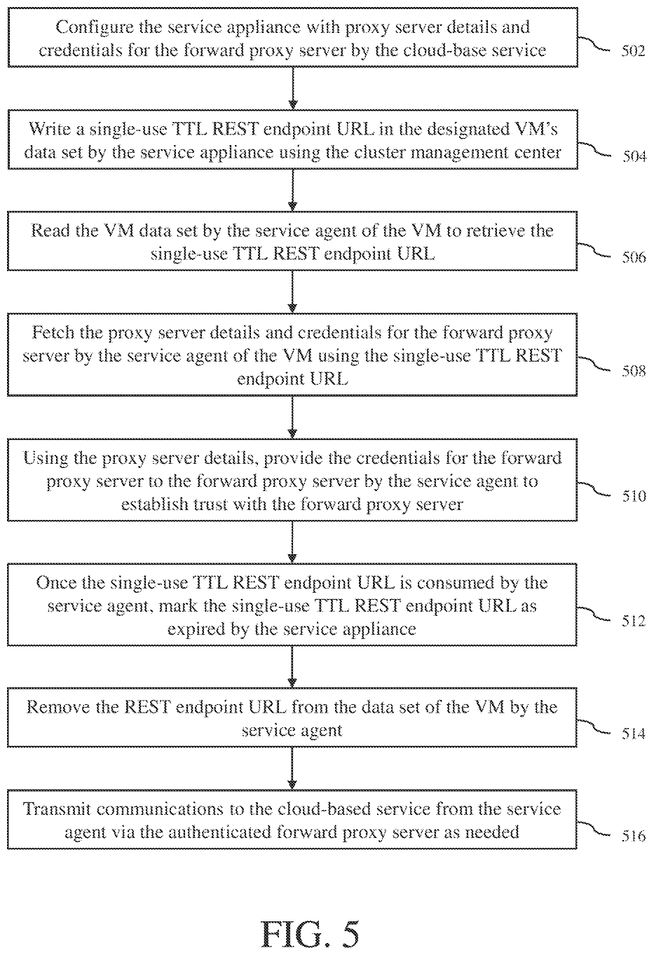

A process of sharing proxy server details and credentials for the forward proxy server 108 with a service agent 128 running in a designated VM 124 in the distributed computing system 100 in accordance with an embodiment of the invention is described with reference to a process flow diagram of FIG. 5. The process begins at step 502, where the service appliance 138 is configured with proxy server details and credentials for the forward proxy server 108 by the cloud-base service 102. In an embodiment, the proxy server details may include the address, e.g., the URL, of the forward proxy server 108. The credentials for the forward proxy server may include username and password, or other authenticating data. These credentials can be used by the service agent 128 of the target VM 124 to establish trust with the forward proxy server 108 and communicate with the cloud-based service 102 via the forward proxy server 108.

Next, at step 504, a single-use TTL REST endpoint URL is written in the designated VM's data set by the service appliance 138 using the cluster management center 136. In an embodiment, the data set API of the cluster management center 136 is used to write the single-use TTL REST endpoint URL in the VM's data set. This REST endpoint URL can only be used one time. Thus, once the REST endpoint URL has been consumed or used, the REST endpoint URL cannot be used again to retrieve the proxy server details and credentials for the forward proxy server 108. The REST endpoint URL is also set with an expiry, which defines the lifespan duration, or the TTL duration, of the REST endpoint URL. Thus, even if the REST endpoint URL is not used, the REST endpoint URL will expire when the lifespan duration of the REST endpoint URL has elapsed. Once the REST endpoint URL has expired, the REST endpoint URL cannot be used again to retrieve the proxy server details and credentials for the forward proxy server 108. In an embodiment, the single-use TTL REST endpoint URL is a signed URL to ensure that the service agent 128 is talking to a trusted resource, which can prevent the man in the middle (MITM) attack.

Next, at step 506, once the data set of the VM 124 is populated with the single-use TTL REST endpoint URL, the VM data set is read by the service agent 128 of the VM 124 to retrieve the single-use TTL REST endpoint URL. Next, at step 508, the proxy server details and credentials for the forward proxy server 108 are fetched by the service agent 128 of the VM 124 using the single-use TTL REST endpoint URL. Next, at step 510, using the proxy server details, the credentials for the forward proxy server 108 are provided to the forward proxy server by the service agent 128 to establish trust with the forward proxy server. That is, by providing the right credentials, the service agent 128 is authenticated as a trusted entity by the forward proxy server 108.

Next, at step 512, once the single-use TTL REST endpoint URL is consumed by the service agent 128, the single-use TTL REST endpoint URL is marked as expired by the service appliance 138. In an embodiment, the single-use TTL REST endpoint URL is invalidated so that the proxy server details and credentials for the forward proxy server 108 will not be provided if the single-use TTL REST endpoint URL is again invoked by any entity. Next, at step 514, the, the proxy server details and credentials for the forward proxy server 108 is removed from the data set of the VM 124 by the service agent 128.

Next, at step 516, after the service agent 128 has been authenticated by the forward proxy server 108, communications are transmitted to the cloud-based service 102 from the service agent 128 via the forward proxy server as needed. In an embodiment, the service agent 128 runs as an administrator or root user, which allows the service agent to write to and read from the data set of the VM.

Since the single-use TTL REST endpoint URL used to receive the proxy server details and proxy server credentials is a single-use URL, after the single-use TTL REST endpoint URL has been accessed once, any subsequent use of the single-use TTL REST endpoint URL will not return the proxy server details and proxy server credentials. Thus, after the single-use TTL REST endpoint URL has been used by the service agent 128, unauthorized person or process cannot use the single-use TTL REST endpoint URL to access the secret information, i.e., the proxy server details and proxy server credentials.

Even if the single-use TTL REST endpoint URL is not consumed by the service agent 128, since the single-use TTL REST endpoint URL is a TTL URL, the single-use TTL REST endpoint URL will expire, if the single-use TTL REST endpoint URL is not accessed within the stipulated time, and any subsequent use of the single-use TTL REST endpoint URL will not return the proxy server details and proxy server credentials. Thus, after the set time for the single-use TTL REST endpoint URL has passed, unauthorized person or process cannot use the single-use TTL REST endpoint URL to access the secret information, e.g., the proxy server details and proxy server credentials.

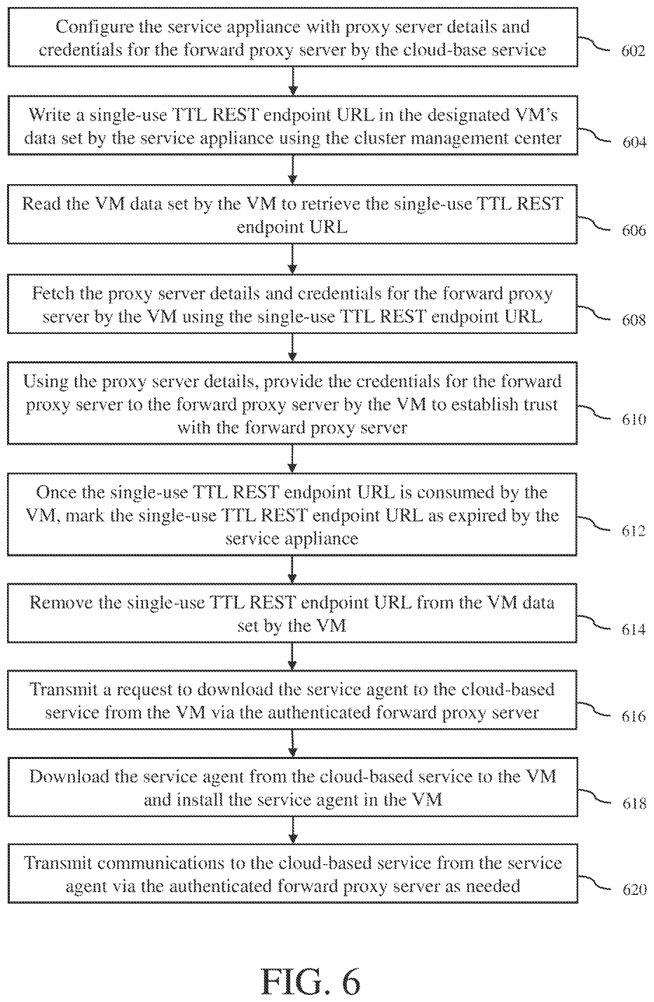

The secure secret sharing approach in accordance with embodiments of the invention may also be used by a designated VM 124 to communicate with the cloud-based service to download and install the service agent 128. A process of sharing proxy server details and credentials for the forward proxy server 108 with a designated VM 124 in the distributed computing system 100 to download a service agent from the cloud-based service 102 in accordance with an embodiment of the invention is described with reference to a process flow diagram of FIG. 6. The process begins at step 602, where the service appliance 138 is configured with proxy server details and credentials for the forward proxy server 108 by the cloud-base service 102. In an embodiment, the proxy server details may include the address, e.g., the URL, of the forward proxy server 108. The credentials for the forward proxy server may include username and password, or other authenticating data. These credentials can be used by the designated VM 124 to establish trust with the forward proxy server 108 and communicate with the cloud-based service 102 via the forward proxy server 108.

Next, at step 604, a single-use TTL REST endpoint URL is written in the designated VM's data set by the service appliance 138 using the cluster management center 136. In an embodiment, the data set API of the cluster management center 136 is used to write the single-use TTL REST endpoint URL in the VM's data set.

Next, at step 606, once the data set of the VM 124 is populated with the single-use TTL REST endpoint URL, the VM data set is read by the VM 124 to retrieve the single-use TTL REST endpoint URL. Next, at step 608, the proxy server details and credentials for the forward proxy server 108 are fetched by the VM 124 using the single-use TTL REST endpoint URL. Next, at step 610, using the proxy server details, the credentials for the forward proxy server 108 are provided to the forward proxy server by the VM 124 to establish trust with the forward proxy server.

Next, at step 612, once the single-use TTL REST endpoint URL is consumed by the VM 124, the single-use TTL REST endpoint URL is marked as expired by the service appliance 138. At step 614, the single-use TTL REST endpoint URL is removed from the VM data set by the VM 124.

Next, at step 616, a request to download the service agent 128 is transmitted to the cloud-based service 102 from the VM 124 via the forward proxy server 108. Next, at step 618, the service agent 128 is downloaded from the cloud-based service 102 to the VM 124 and installed in the VM 124. Next, at step 620, communications from the service agent 128 to the cloud-based service 102 are transmitted via the forward proxy server 108.

Again, since the single-use TTL REST endpoint URL used to receive the proxy server details and proxy server credentials is a single-use URL, after the single-use TTL REST endpoint URL has been accessed once, any subsequent use of the single-use TTL REST endpoint URL will not return the proxy server details and proxy server credentials. Thus, after the single-use TTL REST endpoint URL has been used by the designated VM 124, unauthorized person or process cannot use the single-use TTL REST endpoint URL to access the secret information, i.e., the proxy server details and proxy server credentials.

Furthermore, even if the single-use TTL REST endpoint URL is not consumed by the designated VM 124, since the single-use TTL REST endpoint URL is a TTL URL, the REST endpoint URL will expire if the URL is not accessed within the stipulated time, and any subsequent use of the REST endpoint URL will not return the proxy server details and proxy server credentials. Thus, after the set time for the single-use TTL REST endpoint URL has passed, unauthorized person or process cannot use the single-use TTL REST endpoint URL to access the secret information, i.e., the proxy server details and proxy server credentials.

Although the secure secret sharing approach in accordance with embodiments of the invention has been described with respect to sharing authentication data with a designated VM or with a service agent running in the VM, the secure secret sharing approach may be used to share any secret information with one or more entities running in any computing environment. In addition, the shared secret information can be used for other operations or tasks, in addition to establishing trust with a server.

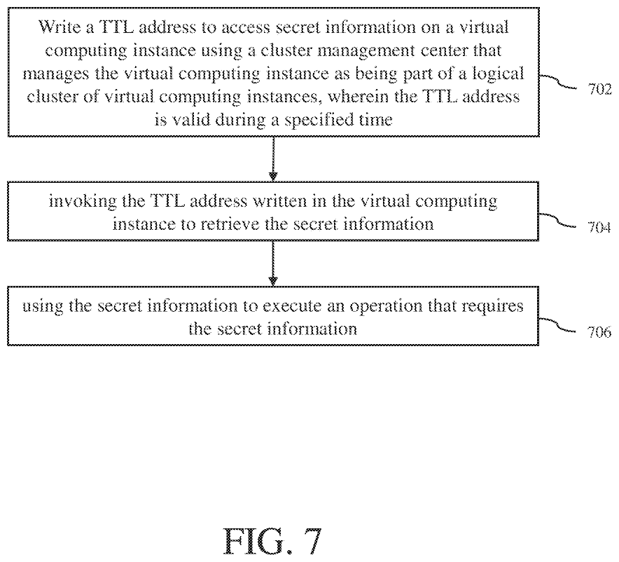

A computer-implemented method for sharing secrets with virtual computing instances in a distributed system in accordance with an embodiment of the invention is described with reference to a flow diagram of FIG. 7. At block 702, a time-to-live (TTL) address is written in a virtual computing instance to access secret information using a cluster management center that manages the virtual computing instance as part of a logical cluster of virtual computing instances, where the TTL address is valid during a specified time. At block 704, the TTL address written in the virtual computing instance is invoked to retrieve the secret information. At block 706, the secret information is used to execute an operation that requires the secret information.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for sharing secrets with virtual computing instances in a distributed system, the method comprising:
writing a time-to-live (TTL) address in a virtual computing instance to access secret information using a cluster management center that manages the virtual computing instance as part of a logical cluster of virtual computing instances, wherein the TTL address is valid during a specified time;
invoking the TTL address written in the virtual computing instance to retrieve the secret information; and
using the secret information to execute an operation that requires the secret information.

2. The computer-implemented method of claim 1, wherein the TTL address is a single-use TTL address that provides the secret information when the single-use address is invoked during the specified time.

3. The computer-implemented method of claim 2, further comprising invalidating the TTL address after the TTL address is invoked for the first time.

4. The computer-implemented method of claim 1, wherein the TTL address is a TTL REST endpoint Uniform Resource Locator (URL).

5. The computer-implemented method of claim 4, wherein the TTL address is a single-use TTL REST endpoint URL.

6. The computer-implemented method of claim 1, wherein writing the TLL address is writing the TTL address in data set of the virtual computing instance using a data set application programming interface (API) of the cluster management center.

7. The computer-implemented method of claim 1, wherein the secret information includes authentication data and wherein using the secret information includes using the authentication data by an agent running on the virtual computing instance to establish trust with a forward proxy server to communicate with a cloud-based service through the forward proxy server.

8. The computer-implemented method of claim 1, wherein the secret information includes authentication data and wherein using the secret information includes using the authentication data by the virtual computing instance to establish trust with a forward proxy server to download an agent from a cloud-based service through the forward proxy server to be installed in the virtual computing instance.

9. A non-transitory computer-readable storage medium containing program instructions for sharing secrets with virtual computing instances in a distributed system, wherein execution of the program instructions by one or more processors of a computer causes the one or more processors to perform steps comprising:
writing a time-to-live (TTL) address in a virtual computing instance to access secret information using a cluster management center that manages the virtual computing instance as part of a logical cluster of virtual computing instances, wherein the TTL address is valid during a specified time;
invoking the TTL address written in the virtual computing instance to retrieve the secret information; and
using the secret information to execute an operation that requires the secret information.

10. The computer-readable storage medium of claim 9, wherein the TTL address is a single-use TTL address that provides the secret information when the single-use address is invoked during the specified time.

11. The computer-readable storage medium of claim 10, wherein the steps further comprise invalidating the TTL address after the TTL address is invoked for the first time.

12. The computer-readable storage medium of claim 9, wherein the TTL address is a TTL REST endpoint Uniform Resource Locator (URL).

13. The computer-readable storage medium of claim 12, wherein the TTL address is a single-use TTL REST endpoint URL.

14. The computer-readable storage medium of claim 9, wherein writing the TLL address is writing the TTL address in data set of the virtual computing instance using a data set application programming interface (API) of the cluster management center.

15. The computer-readable storage medium of claim 9, wherein the secret information includes authentication data and wherein using the secret information includes using the authentication data by an agent running on the virtual computing instance to establish trust with a forward proxy server to communicate with a cloud-based service through the forward proxy server.

16. The computer-readable storage medium of claim 9, wherein the secret information includes authentication data and wherein using the secret information includes using the authentication data by the virtual computing instance to establish trust with a forward proxy server to download an agent from a cloud-based service through the forward proxy server to be installed in the virtual computing instance.

17. A system comprising:
memory; and
at least one processor configured to:
write a time-to-live (TTL) address in a virtual computing instance to access secret information using a cluster management center that manages the virtual computing instance as part of a logical cluster of virtual computing instances, wherein the TTL address is valid during a specified time;
invoke the TTL address written in the virtual computing instance to retrieve the secret information; and
use the secret information to execute an operation that requires the secret information.

18. The system of claim 17, wherein the TTL address is a single-use TTL address that provides the secret information when the single-use address is invoked during the specified time.

19. The system of claim 18, wherein the TTL address is a single-use TTL REST endpoint Uniform Resource Locator (URL).

20. The computer-implemented method of claim 1, wherein writing the TLL address is writing the TTL address in data set of the virtual computing instance using a data set application programming interface (API) of the cluster management center.
